(19) United States
(12) Patent Application Publication
(10) Pub. No.: US 2017/0001547 A1
(43) Pub. Date: Jan. 5, 2017

(54) AIR-CONDITIONING MODULE FOR A VEHICLE SEAT

(71) Applicant: I.G. BAUERHIN GMBH, GRUENDAU (DE)

(72) Inventor: STEFAN BAUER, ALZENAU (DE)

(21) Appl. No.: 15/193,262

(22) Filed: Jun. 27, 2016

(30) Foreign Application Priority Data
Jul. 3, 2015 (DE) 10 2015 008 507.7

(51) Int. Cl. B60N 2/56

(52) U.S. Cl. CPC B60N 2/5657; B60N 2/5642

(57) ABSTRACT

An air-conditioning module for a vehicle seat with an air distribution layer is covered at least on the one side by at least one cover layer. The module comprises a radial fan whose housing is held at least in part by a strap that is cut out of the cover layer and has an outer contour defined by at least four corner points with two respective sides opposite to each other. One of the two sides opposite to each other defines a short base side and the other defines a long base side. Parts of this radial fan housing are at least in part, covered by this strap. Viewed in projection onto the cover layer the strap is offset with respect to the outer contour with the long base side towards the short base side. The strap, at least in the area of the short base side and in the area of the corners of the long base side, encompasses the housing of the radial fan, at least in part, and is connected to the cover layer at the end areas of the same.

### BACKGROUND OF THE INVENTION

The present invention relates to an air-conditioning module for a vehicle seat.

Such an air-conditioning module comprises an air distribution layer, which is covered by at least one cover layer at least on the one side, and a radial fan having a housing with at least one radial and at least one axial air movement opening, wherein the housing of the radial fan is held at least in part by portions of the cover layer.

The German Patent Publication DE 10 2006 004 465 A1 describes an insert for an air conditioned vehicle seat. The insert comprises at least one air-permeable top cover layer, a three-dimensional air distribution layer underneath it and at least one bottom cover layer having at least one air inlet. The top cover layer and the bottom cover layer are connected to each other along a laterally circumferential edge of the air distribution layer. A ring-shaped component with three sections is arranged at the at least one air inlet, wherein the first section includes a flange that is used to hold the component, the third section forms a fan receptacle and the second section forms a structure that decouples the first and the second section, wherein the flange of the first section of the ring-shaped component is held covered by the bottom cover layer.

The European Patent Publication EP 2 644 447 A1 discloses a fan arrangement for a vehicle seat with a radial fan having a fan housing. The fan housing has an axial and a radial housing opening. The fan housing is positioned with its axial housing opening on a carrier plate that is part of a seat frame and is held thereto via at least one retaining element. An interim layer consisting of a reversibly deformable material is positioned in the support area between the fan housing and the carrier plate. The retaining element can be a designed in the form of a spring clip, for example.

The U.S. Patent Publication US 2008/0191521 A1 describes a ventilated seat, where the back rest or seat cushion components are ventilated via an air distribution layer that is integrated in the seat area or in the backrest. The air distribution layer is covered by a top and a bottom cover layer. The top cover layer is provided with a multitude of openings and the bottom cover layer has an opening to which a radial fan is attached using fastening components having latching connectors. The radial fan is held at the seat carrying structure using an additional fastening structure.

### SUMMARY OF THE INVENTION

The objective of the present invention is to create an air-conditioning module for which additional plastic components/plastic connectors for attaching a radial fan to the air-conditioning module can be omitted.

This objective, as well as other objectives which will become apparent from the discussion that follows, is achieved, according to the present invention, by providing an air-conditioning module for a vehicle seat wherein the fan housing is held in place by means of a strap cut out of the cover layer that has an outer contour defined by at least four corner points with two respective sides opposite each other. The one of the two sides that are opposite to each other is shorter and defines a short base side and the other side of the two sides that are opposite to each other is longer than this short base side and defines a long base side. The sides of the other two sides that are opposite to each other each extend at an angle greater than 90° relative to the short base side. Parts of the radial fan housing are at least in part covered by this strap at the side of the radial fan housing that faces away from the top cover layer. Viewed in projection to the top cover layer, the strap is offset with reference to its outer contour with the long base side towards the short base side. The strap encompasses at least partially the housing of the radial fan at least in the area of the short base side and in the area of the edges of the long base side and is connected to the top cover layer at their end regions. Here, the radial fan is held such that it essentially covers the air distribution layer in that area where the strap is cut out of the cover layer.

The cover layer, and thus also the strap, are preferably made from non-woven, needle felt, felt, fabric or knits; in addition, the material can have airtight properties by being provided with a respective coating. However, it is also provided that the material used, such as nonwoven, needle felt, felt, fabric or nits, has such a density that it prevents air from penetrating or allows only a negligible amount to penetrate.

A particular advantage of the air-conditioning module is that the radial fan is connected to the air distribution layer even without plastic connectors using the strap formed from the cover layer. However, the strap can also be provided with an additional adhesive strip for additionally securing the radial fan housing. Such an adhesive strip or adhesive pad can extend from the short base side of the strap's outer contour via the strap's long base side to the opposite side of the air distribution layer and can be glued there. The adhesive strip is applied or attached such that there are no functional restrictions to the radial fan. The overall height of the air-conditioning module is kept low due to the radial fan being in functional or flow connection with the air-conditioning module without additional fastening components and can be held by the strap alone.

A significant aspect of the air-conditioning module according to the invention is that the attachment of the radial fan is carried out directly with parts of the cover layer that covers the air distribution layer. To allow for this, the strap must have a fictitious contour that is defined by four corner points such that a quadrilateral arises of which the one of two of the sides opposite each other is longer than the other side of this pair. The fan with its housing is positioned under this strap that is connected to the cover layer with the shorter side, referred to as short base side, and the longer side of the strap, referred to as long base side is shifted toward the shorter side. Since the strap tapers off toward the short base side when viewed from the long base side, the corners of the strap in the area of the long base side are located above an edge area of the cover layer that defines the cut out when viewed in the projection onto the cut-out in the cover layer. Thus, the strap can be attached to the cover layer that covers the air distribution layer such that the radial fan is configured in its position below the strap.

Preferably, the strap is cut out of the cover layer with respective positioning of the radial fan such that the long base side corresponds to a portion of the edge of the cover layer.

Preferably, the sides of the other two sides, which are opposite to each other and respectively connect the ends of the long base side and of the short base side to each other, should extend toward the short base side at an angle greater than 120° such that when the long base side is shifted toward the short base side a sufficient overlap arises between the cover layer and the corners of the strap in the area of the long base side. The corner areas of the strap can thus encompass the edge of the fan housing to attach it then to the cover layer. On the other hand, it is also preferable that the two other sides that originate from the ends of the short base side extend at an angle of less than 150° thereto.

The strap can have very different shapes especially depending on the type of the radial fan that is used on the form and size of its housing. In certain embodiments, in order to fasten the radial fan, it should be noted that the long base side is shifted perpendicular toward the short base side.

It is furthermore provided that the radial fan is held under the strap such that the radial air movement opening thereof is located in the area of the long base side of the strap.

Preferably, the strap is cut out of the cover layer such that at the short base side of its outer contour it is still connected to that portion of the cover layer that covers the air distribution layer. The strap is thus an integral component of the cover layer in each stage of the air-conditioning module production.

Within the scope of the inventive concept, it is also provided that the two sides of the outer contour of the strap that connect the short and the long base sides respectively to each other are divided into two sections and that these each extend at an angle to each other such that they form an angle less than 180° and greater than 90° at the outer side. With this shape of the strap, the outer contour is again defined by the four outer corner points such that a long and a short base side arise so that the width of the strap in relation to its outer contour tapers off towards the short base side when viewed from the long base side.

A strap as described above can have a Y-shaped geometry in one preferred embodiment.

With preferred dimensions of the strap, the long base side of the outer contour is designed with the length that is at least 1.5 times the diameter of the radial fan housing in the area of this long base side.

In one particular advantageous shape of the strap, the four corner points that define the shape of the strap define an essentially trapezoidal outer contour.

For a full understanding of the present invention, reference should now be made to the following detailed description of the preferred embodiments of the invention as illustrated in the accompanying drawings.

### BRIEF DESCRIPTION OF THE DRAWINGS

FIG. 1A is a top view of a section of an air-conditioning module according to the invention.

FIG. 1B is a cross-sectional view, along the section line 1B-1B in FIG. 1A.

FIGS. 2A to 2C show various shapes of the strap as it is also shown in FIG. 1A.

FIG. 3 is a top view of a section of an air-conditioning module with a strap in a V-shape.

FIG. 4 shows an arrangement, in which the strap has a funnel-shaped outer contour.

FIG. 5 shows an arrangement in which the strap has a Y-shape.

FIG. 6 shows an arrangement with a strap having an outer contour similar to a Y-shape, wherein the cut lines along which the strap is cut out from the cover layer are indicated, and in which the strap is additionally shown in a position where the long base line is shifted towards the short base line.

FIG. 7 shows the strap of FIG. 6 with additional reference lines that define an outer contour of the strap with its dimensioning.

FIG. 8 shows a top view of an air-conditioning module with another possible shape of the strap.

### THE DESCRIPTION OF THE PREFERRED EMBODIMENTS

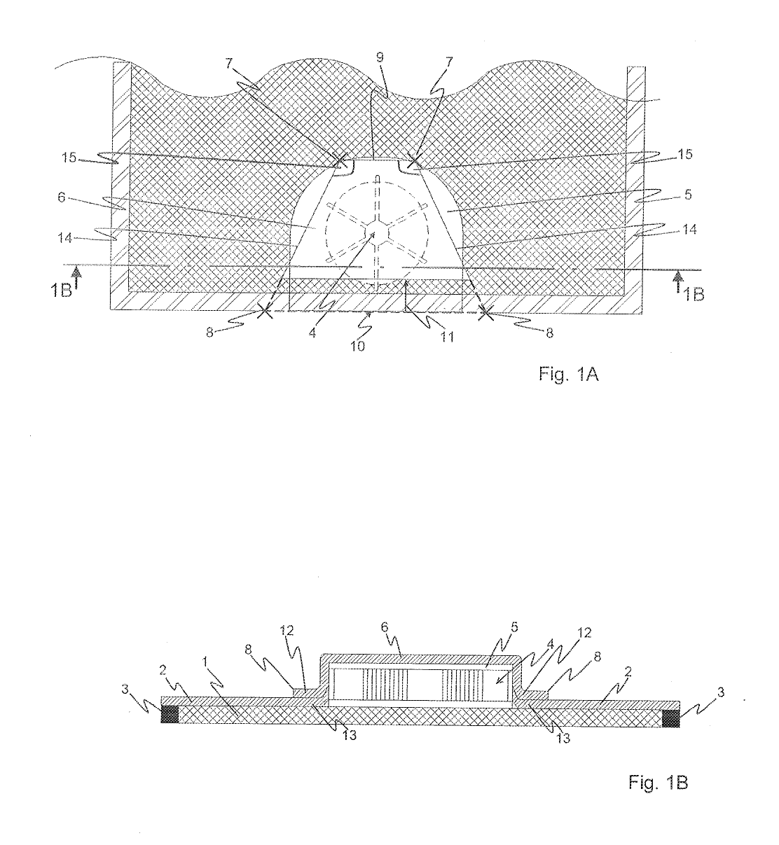

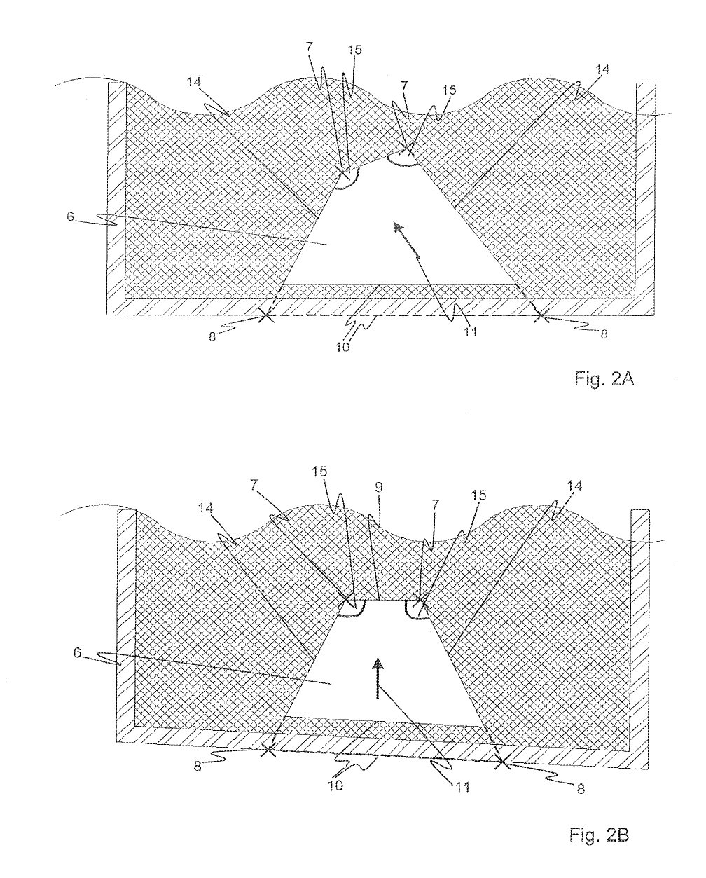

The preferred embodiments of the present invention will now be described with reference to FIGS. 1-8 of the drawings. Identical elements in the various figures are designated with the same reference numerals.

It shall be pointed out that information in the following description regarding individual figures and their elements is transferrable to other figures even if not described again in detail for the other figures.

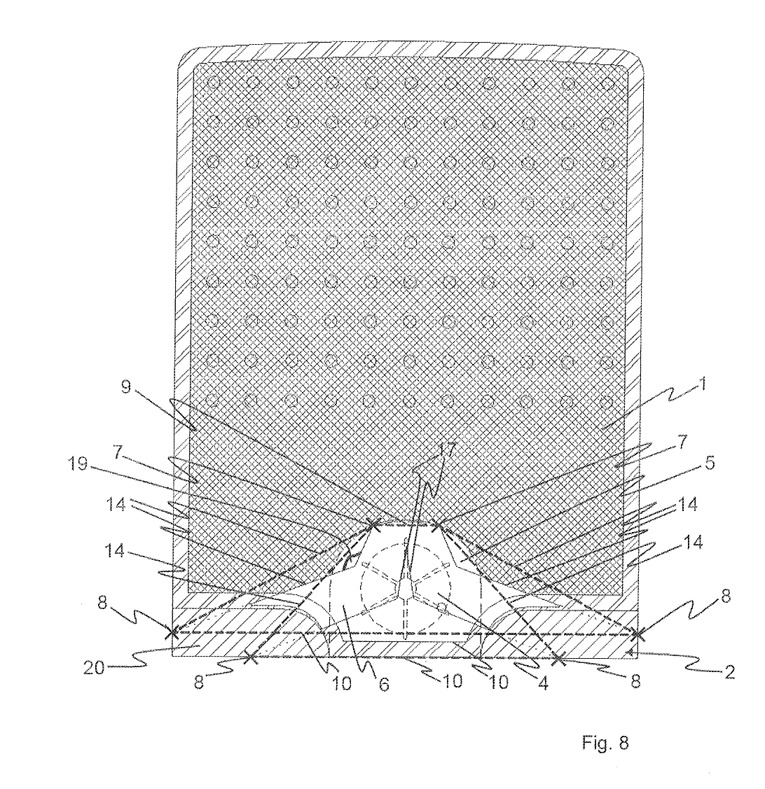

The air-conditioning module for a vehicle seat, which is presented in greater detail in FIGS. 1A, 1B and 8, comprises, as can be seen especially in FIG. 1B, an air distribution layer 1 that is covered by a cover layer 2 at one side, in FIG. 1B the top side. In addition, this air distribution layer can also be covered at the bottom side with an additionally but not shown cover layer.

At the outside, the air distribution layer 1 is restricted by a spacer component 3 to which the edge of the air distribution layer 1 is fastened; however, the spacer component 3 could also be omitted or replaced by other means.

The air distribution layer 1 is made of non-woven, felt, fabric, knits, open-cell foam, ribbon-like spirals, waterproof foil, bubble wrap or preferred of a knitted spacer fabric that allows for sufficient air circulation inside the air-conditioning module.

The cover layer 2 and the spacer material 3 are, on the other hand, essentially airtight to separate the air distribution layer 1 from the surrounding area.

The air-conditioning module can be inserted into a respective indentation or recess of a not shown cushion section such that the bottom side of the air distribution layer 1 rests on the bottom surface of the indentation or recess, which delineates the space of the air distribution layer 1 at the bottom side. However, it is also provided that the bottom side of the air distribution layer 1 is covered with an additional cover layer that is attached to the bottom side of the spacer component 3.

Located at the top side of the air distribution layer 1 is a radial fan 4, which with its housing 5 is positioned on the air distribution layer 1 such that its axial air movement opening points to the air distribution layer 1, while the radial air movement opening is directed towards the edge of the air-conditioning module.

The radial fan 4 or its housing 5, respectively, is held at the air distribution layer 1 by a portion of the cover layer 2, which is formed from the cover layer 2 in the shape of a strap 6 as is demonstrated based on FIG. 1A.

This strap 6 can have different shapes; however, these different shapes have one common feature in that a designed outer contour of the strap 6 can be defined by at least 4 corner points, wherein two of these corner points are designated with the reference sign 7 and the two other corner points with the reference sign 8 in the figures. These four corner points 7, 8 result in a designed outer contour of the strap 6 with two respective sides opposite each other, wherein the one of the two sides that are opposite to each other is shorter and defines a short base side 9 and the other side of the two sides that are opposite to each other is longer than this short base side 9 and defines a long base side 10. This measure results, for example, in a shape of the strap 6 as presented in FIG. 1A corresponding to a trapezoid.

To fasten the radial fan 4 to the air distribution layer 1, it is positioned underneath the strap 6 in the air distribution layer 1 and the strap 6 is placed on the top side of the housing 5. For this purpose, the long base side 10 of the strap 6 is shifted towards the short base side 9 in the direction of the arrow 11. Due to the different shapes that the strap 6 can assume in the different embodiments, the long base side 10 of the strap 6 should be shifted perpendicular in the direction of the short base side 9; this means in the case of the strap 6 presented in figure LA with a trapezoidal outer contour that the long base side 10 is shifted parallel to the short base side 9 towards the same.

Due to the positioning of strap 6, the corner areas 12 associated with the corner points 8 are laterally circumferential around the housing 5 of the radial fan 4 and end in the edge area 13 of the respective cut-out of the cover layer 2 and can be attached, for example by gluing, at the top side of the cover layer 2.

In order to achieve an overlap of the corner areas 12 of the strap 6 with the edge area 13 of the cut-out, attention must be paid that the two other sides 14 that respectively connect the corner points 7 and 8 of the short base side 9 and of the long base side 10 to each other form an angle 15 toward the short base side 9 that is greater than 90°. In particular depending on the length of the strap 6, that is the distance between the short base side 9 and the long base side 10, this angle 15 should preferably be greater than 120° and less than 150°; in FIG. 1A, the angle 15 is about 115°. Larger angles are preferred from the aspect that the overlap at the corner areas 12 of strap 6 with the edge area 13 of the cover layer 2 is enlarged.

The shape of the strap 6, and thus the shape of the created cut-out in the cover layer 2 depends among other thing on the shape of the housing 5 of the radial fan 4. Attention must be paid that the radial fan 4 with its housing 5 covers the area of the cover layer 2 from which the strap 6 is cut out. In this regard, it is also provided that the surface of a bottom 16 of the housing 5 of the radial fan 4 is dimensioned such that the cut-out in the cover layer 2 is covered completely.

The longitudinal direction of strap 6, that is, in the direction from the short base side 9 towards the long base side 10, the area of the cover layer 2 that is otherwise used to attach the cover layer 2 to the spacer component 3 can be used for the strap 6.

In the following figures, the outer contour of the strap, which each time has a short base side 9 and a long base side 10 is defined by the four corner points 7 and 8 in the different geometries that the strap 6 can assume in the various embodiments. Based on these four corner points 7 and 8, the general teaching of the invention can be easily implemented for the different geometries of the strap 6 by a person skilled in the art. However, the different embodiments do also have specific advantages.

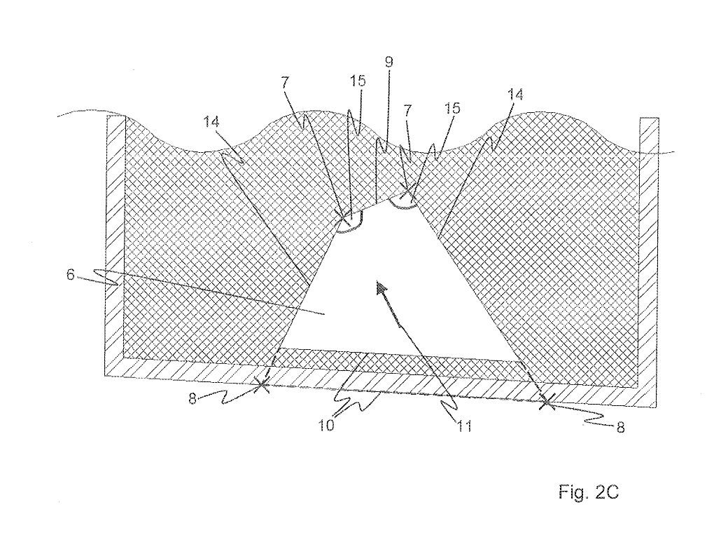

The embodiments presented in FIGS. 2A to 2C are based on the one shown in FIGS. 1A and 1B. The embodiments presented in FIGS. 2A to 2C assume a trapezoidal outer contour of the strap 6 that is defined by the four corner points 7 and 8. In each of the shown examples, the two sides 14 that connect the respective corner points 7 and 8 of the short base side 9 and the long base side 10 to each other extend at an angle 15 relative to the short base side 9 that is greater than 90°. When the long base side 10 of the strap 6 is moved towards the short base side 9, where the strap 6 is still connected to the cover layer 2, in the direction of the arrow 11, this achieves that the corner points 8 are positioned above the cover layer 2 such that they can be connected to the cover layer 2 by encompassing the fan housing 5 as presented in FIG. 1B.

FIGS. 2A to 2C furthermore demonstrate that the strap 6 can be adapted to the geometry of the air distribution layer 1.

While the figures show embodiments where the fan is arranged at one end, that is, at an edge area of the air distribution layer 1, the same could also be positioned in a center area of the air distribution layer 1 within the scope of the invention. In such cases, the strap 6 is cut out of the cover layer 2 with an additional cut along the base side 10 besides the cuts along the sides 14 of the quadrangular outer contour of the strap 6. The strap 6 could also be separated first along the short base side 9 in the different embodiments if this were necessary for production-related reasons; however, the strap 6 would then have to be connected again to the cover layer 2 along the short base side 9, possibly by an additional adhesive strip or adhesive pad.

In FIG. 1B, the corner areas 12 of the strap 6 are attached at the top side of the cover layer 2. However, it is also conceivable to arrange the strap corners 12 underneath the cover layer 2, that is between cover layer 2 and air distribution layer 1 although this my mean additional expenditures.

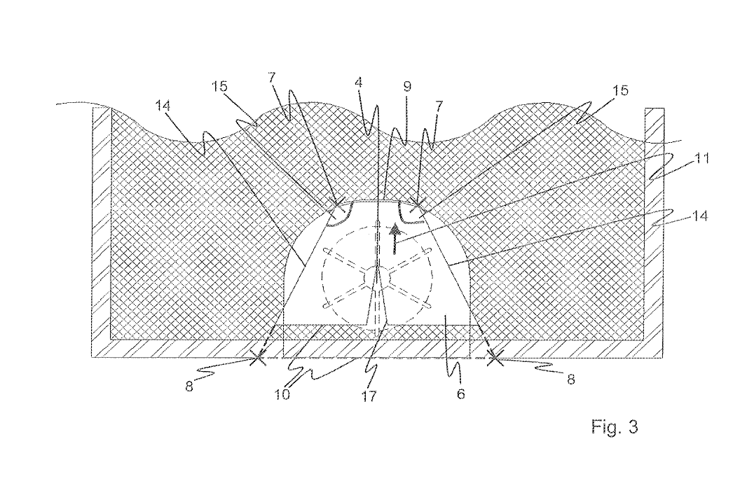

FIG. 3 shows a top view of a section of an air-conditioning module with a strap 6 in a V-shape. In its outer contour, which again is defined by the four corner points 7 and 8, this strap 6 corresponds to that presented in FIGS. 1A and 1B. In addition, this strap 6 is provided with a slit or a V-shaped cutout 17 approximately in the center of the same between the two sides 14 from the long base side 10. This offers the advantage that the corner areas 12 of the strap 6 can be pulled or positioned further outward to attach the corner areas 12 to the cover layer 2. In this case, it can be advantageous if the strap 6 is slit or cut starting from about the center of the respective side 14 so that this area of the strap 6 is placed flat on the top side of the fan housing 5.

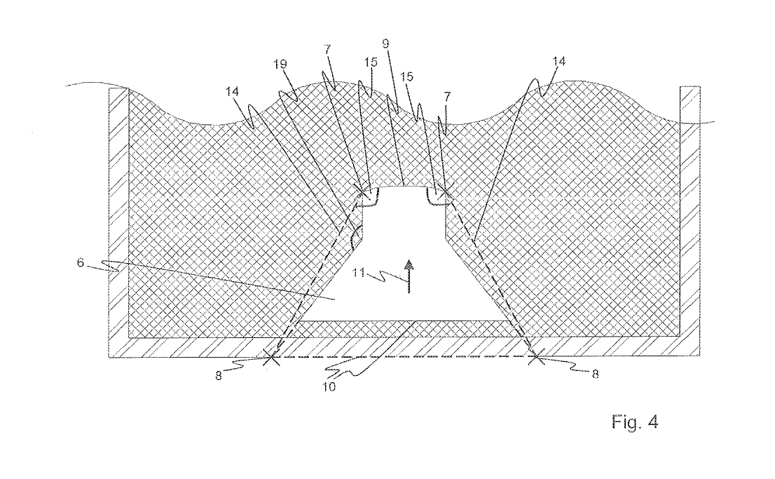

The strap 6 has a funnel-shaped outer contour in FIG. 4. By connecting the four corner points 7 and 8, an outer contour can also be designed with this shape of the strap 6 where the respective connecting line between the corner point 7 and the corner point 8, indicated by a dash-dot line 18, fulfills the condition that it runs relative to the short base side 9 that connects the two corner points 7 at an angle 15 that is greater than 90°.

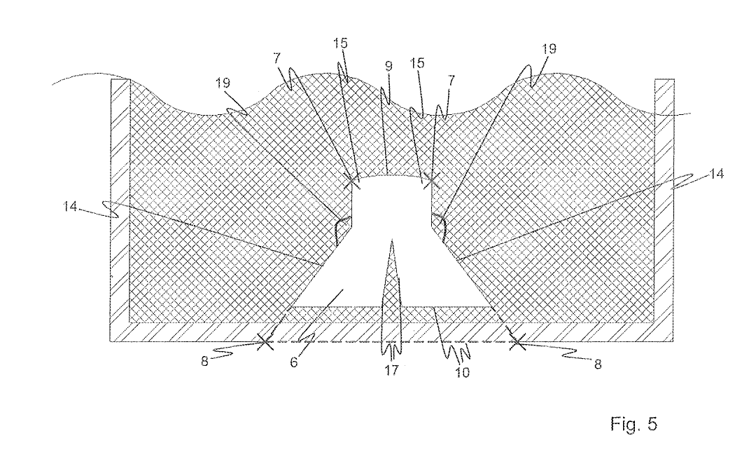

The embodiment of FIG. 5 combines the geometric features of the strap 6 of FIGS. 3 and 4 such that in this regard the information of FIGS. 3 and 4 described above can be used.

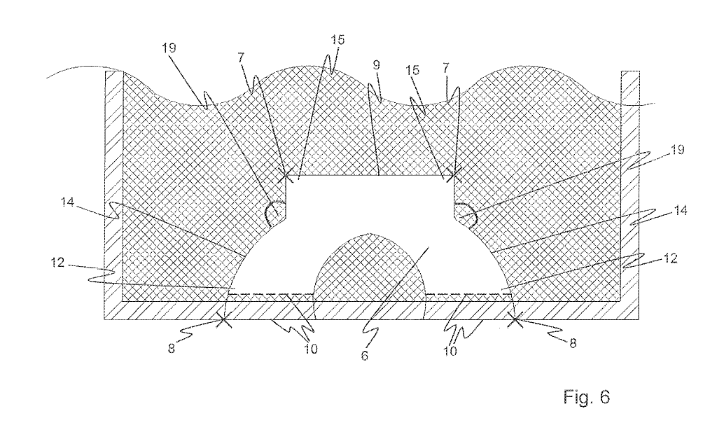

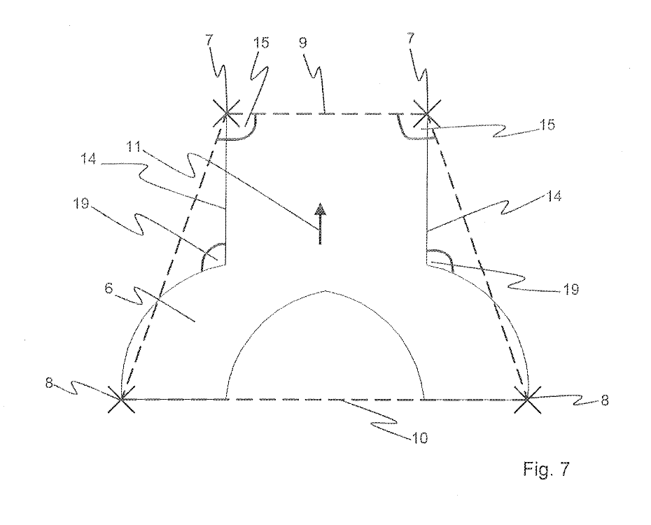

FIG. 6 shows an arrangement with a strap 6 having an outer contour similar to a Y-shape and being presented separate from the cover layer 2 of FIG. 6 additionally in FIG. 7, where the two legs that end in the area of the long base side 10 have a bent outer contour. Also in this embodiment, the four corner points 7 and 8 can define a fictitious outer contour as indicated by the broken line in FIG. 7. Based on FIG. 7, it is apparent that when the long base side 10 is moved towards the short base side 9, a large overlap is achieved between the corner areas 12 of strap 6 and the cover layer 2 that covers the air distribution layer 1.

In the embodiments presented in FIGS. 4 to 7, the funnel-shaped or Y-shaped outer contour can also be characterized in that the two sides 14 that connect the respective ends 7 and 8 of the short and the long base sides 9, 10 to each other, are each divided into two sections such that these sections extend at their outer side under an angle 19 that is between 90° and 180°, wherein an angle 19 approximately in the middle of this range of 120° to 160° is preferable for certain areas of application.

Based on the Figures it is also apparent that advantageously the length of the long base side 10 is at least 1.5 times the diameter of the housing 5 of a radial fan 4 in the area of this long base side 10. It is furthermore preferable if the long base side 10 (as an imaginary connection line between the corner points 8) has at least twice the length of the short base side 9.

FIG. 8 shows a top view of a complete air-conditioning module with an additional possible geometry of the strap 6 with an arrangement of the radial fan 4 in the area of the edge of the same. Starting with a rectangular geometry of the air distribution layer 1 and a rectangular geometry of the cover layer 2 that covers the air distribution layer 1, in the end the final geometry of the air-conditioning module, where the radial fan 4 is located, deviates from the same. When manufacturing such an air-conditioning module, the area sections of the cover layer 2 that are designated with the reference sign 20 in FIG. 8 are not needed to cover the air distribution layer 1. These area sections 20 are typically removed. In the presented exemplary embodiment, the areas of these area sections 20 are assigned to the strap 6 such that they can be used to encompass the housing 5 of the radial fan 4 and to attach the strap 6 to the cover layer 2 above the air distribution layer 1. Here, the strap 6 shows a Y-shape comparable to that of strap 6 of FIG. 5, however with wide open legs. The outer contour of strap 6 is for one defined by the two corner points 7, whose connecting line forms the short base side 9, and for another by the two corner points 8, whose connecting line forms the long base side 10. The long base side 10 can be defined alternatively by the two outer corner points 8 or the two inner corner points 8 to create the outer contour for defining the geometry of strap 6.

There has thus been shown and described a novel air-conditioning module for a vehicle seat which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. Air-conditioning module for a vehicle seat with an air distribution layer that is covered at least on the one side by at least one cover layer and with a radial fan having a housing with at least one radial and one axial air movement opening, wherein the housing of the radial fan is held in place, at least in part, by portions of the cover layer; the improvement wherein a strap is cut out of the cover layer and has an outer contour defined by at least four corner points, with two respective sides opposite to each other; wherein one of the two sides opposite to each other is shorter and defines a short base side and the other of these two sides opposite to each other is longer than the short base side and defines a long base side; wherein the other two sides that are opposite to each other each extend at an angle greater than 90° with respect to the short base side, such that parts of the radial fan housing are at least in part covered by the strap on the side of the radial fan housing that faces away from the cover layer; wherein, viewed in projection onto the cover layer, the strap is offset with reference to its outer contour with the long base side towards the short base side, and the strap encompasses at least partially the housing of the radial fan, at least in the area of the short base side, and in the area of the edges of the long base side the strap is connected to the cover layer at these end regions; and wherein the radial fan is held such that it essentially covers the air distribution layer in that area where the strap is cut out of the cover layer.

2. Air-conditioning module as in claim 1, wherein the other two sides that are opposite to each other each extend at an angle greater than 120° and less than 150° with respect to the short base side.

3. Air-conditioning module as in claim 1, wherein the long base side is shifted in a perpendicular direction towards the short base side.

4. Air-conditioning module as in claim 1, wherein the radial fan is retained such that the radial air movement opening thereof is located in the area of the long base side of the strap.

5. Air-conditioning module as in claim 1, wherein the strap is cut out of the cover layer such that at the short base side of its outer contour remains connected to that portion of the cover layer that covers the air distribution layer.

6. Air-conditioning module as in claim 1, wherein the two sides of the outer contour of the strap that connect the short and the long base sides respectively, to each other are divided into two sections, and wherein these sections each extend at an angle to each other such that they form an angle of less than 180° and greater than 90° at the outer side.

7. Air-conditioning module as in claim 6, wherein the strap has a Y-shaped geometry.

8. Air-conditioning module as in claim 1, wherein the long base side of the outer contour has a length that is at least 1.5 times the diameter of the housing of the radial fan in the area of this long base side.

9. Air-conditioning module as in claim 1, wherein an essentially trapezoidal outer contour is defined by the four corner points.
